(19) United States
(12) Patent Application Publication
(10) Pub. No.: US 2002/0180736 A1
(43) Pub. Date: Dec. 5, 2002

(54) Data entry control system

(76) Inventors: Martin John Millmore, Reading (GB); Andrew Richard Rundell, Reading (GB); John Patrick Bard, Rickmansworth (GB)

Correspondence Address: SWIDLER BERLIN SHEREFF FRIEDMAN, LLP, 3000 K STREET, NW, BOX IP, WASHINGTON, DC, 20007, US

(21) Appl. No.: 09/867,679

(22) Filed: May 31, 2001

(51) Int. Cl. G06T 11/20

(52) U.S. Cl. 345/440

(57) ABSTRACT

A system and method for controlling the appearance of a data entry form on a display to which it is connected for use in entering data into a database, the system comprising a store for storing attribute data defining attributes of a data entry form having at least one data entry field and, for the one data entry field, storing data values and corresponding attribute data defining at least one further data entry field for each of at least two data values which may be entered in the one data entry field; and a controller for causing the data entry form to be displayed on a display in accordance with the stored attribute data, and for monitoring data values entered into said one data entry field, comparing said data value with said prestored data values for that data entry field and, if a match is found, displaying the or each corresponding further data entry field according to the stored attribute data.

### FIELD OF THE INVENTION

The invention relates to a system and method for controlling the appearance of a data entry form on a display.

### DESCRIPTION OF THE PRIOR ART

Many organizations use databases for storing information relating to personnel and other aspects of their business. Typically, each organization wishes to store different types of information although there is often some commonality. For example, although most organizations will want to store the name and address of each employee, organizations in different countries may have different requirements depending upon local legislation. Furthermore, the format of even the common types of information such as the address can vary from country to country.

Conventional database management systems provide interactive forms to enable data to be entered onto a database and typically, these forms are configured by the database supplier in accordance with the customer's requirements. This is time consuming and also makes it difficult for customers to vary their requirements once the database has been installed. Typically, specialist software engineers are required to make these changes.

### SUMMARY OF THE INVENTION

In accordance with a first aspect of the present invention, a system for controlling the appearance of a data entry form on a display to which it is connected for use in entering data into a database comprises a store for storing attribute data defining attributes of a data entry form having at least one data entry field and, for the one data entry field, storing data values and corresponding attribute data defining at least one further data entry field for each of at least two data values which may be entered in the one data entry field; and a controller for causing the data entry form to be displayed on a display in accordance with the stored attribute data, and for monitoring data values entered into said one data entry field, comparing said data value with said prestored data values for that data entry field and, if a match is found, displaying the or each corresponding further data entry field according to the stored attribute data.

In accordance with a second aspect of the present invention, a method for controlling the appearance of a data entry form on a display comprises causing a data entry form to be displayed on a display in accordance with stored attributes, the data entry form having at least one data entry field; monitoring data values entered into said at least one data entry field, comparing said data values with prestored data values for that field and, if a match is found, displaying one or more corresponding further data entry fields.

With this invention, the data entry form itself is dynamically altered as data values are entered so that it is automatically tailored to the user's requirements. At the same time, it enables updates and other changes to be made easily by simply changing the contents of the store rather than having to rewrite computer code defining the forms.

In a simple example, the same software may be supplied to organizations in different countries where the format of addresses is different. When the user enters the country concerned in the appropriate data entry field, the system will recognize from the country information which set of data entry fields should then be displayed for entering the address and these will then be displayed accordingly.

### BRIEF DESCRIPTION OF THE DRAWINGS

An example of a system and method according to the present invention will now be described with reference to the accompanying drawings, in which:

FIG. 1 is a block diagram of the system; and,

FIGS. 2 to 4 are examples of screen displays provided by the system shown in FIG. 1.

### DETAILED DESCRIPTION OF THE EMBODIMENT

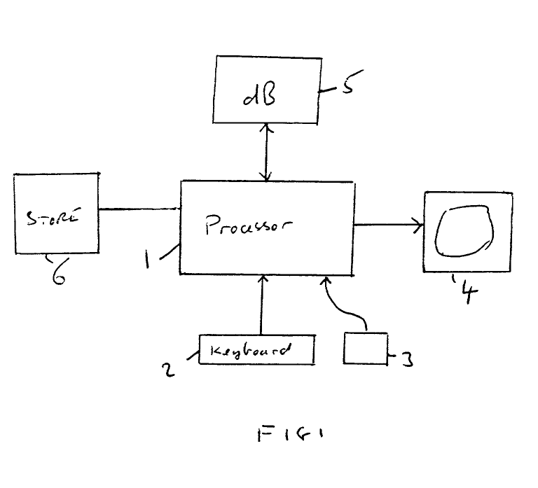

The system shown in FIG. 1 comprises a processor 1 controlled by a keyboard 2 and mouse 3 and connected to a monitor display 4. The processor 1 is connected to a database 5 which may be local to the processor or located elsewhere in the world, the processor 1 being connected to the database 5 via a suitable link such as a telephone line or the like. The database 5 could be located on a single server or distributed across several servers.

A store 6, such as a look-up table, is connected to the processor 1 for storing data defining the format of forms and attribute data relating to one or more data entry fields.

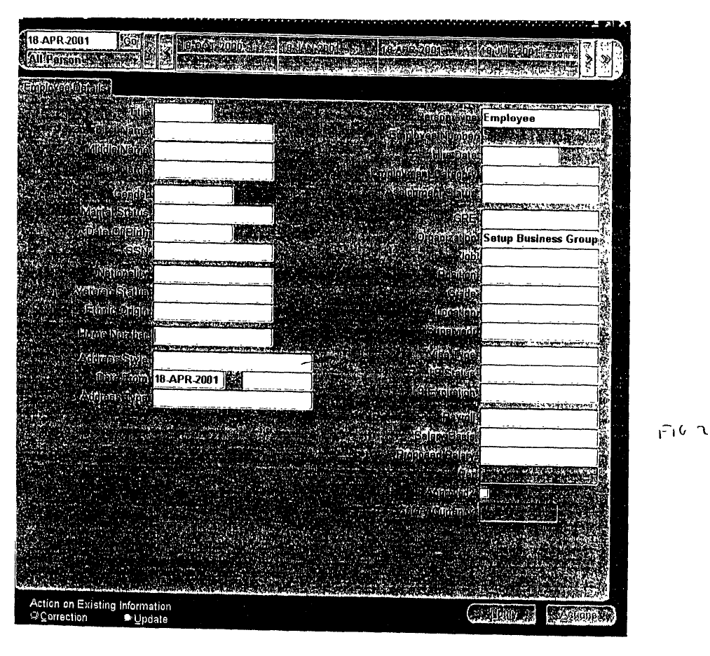

In this example, the entry of basic personnel information will be described. Initially, in response to a user command and format data in the store 6, the processor 1 will display a form of the type shown in FIG. 2. As can be seen, this comprises a set of data entry fields alongside which are field definitions such as “Title”, “First Name” etc. The user enters the appropriate information as requested.

One of the data entry fields is “Address Style” as indicated at 20 and in this field, the user enters the country of residence of the person concerned. In this example, the country may be “United Kingdom” or “United States”.

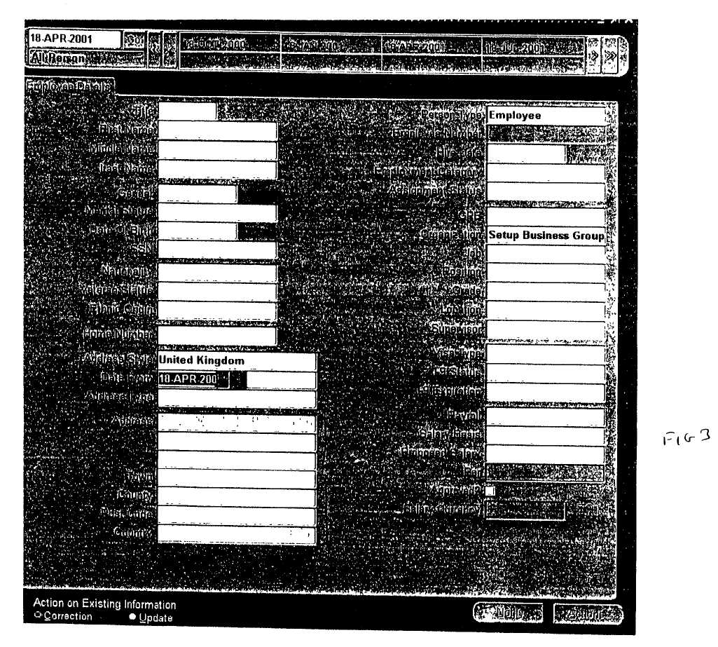

When the user enters the country information in the data entry field 20, the processor 1 then compares that information with country information in the store 6 which is typically a look-up table. For each specified country, the store 6 defines a set of further data entry fields which are to be displayed if a match is found. Thus, if the country entered is “United Kingdom” the processor 1 will obtain from the source 6 a definition of further data entry fields 22 corresponding to a United Kingdom address and these will then be displayed as part of the form and as shown in FIG. 3. The user can then enter the person's address in the correct format for the United Kingdom using the newly displayed data entry fields 22.

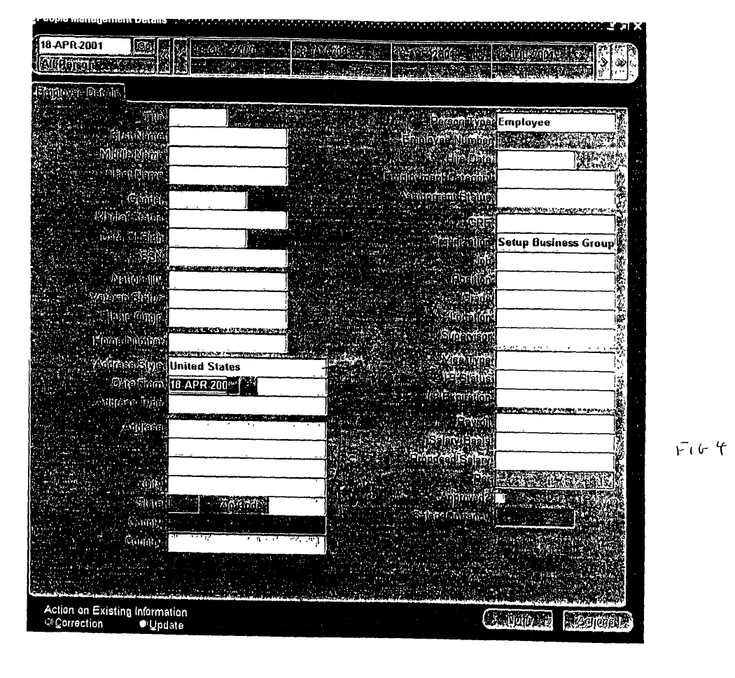

Alternatively, if the user enters “United States” in the data entry field 20, the store 6 will define an alternative set of data entry fields 24 corresponding in form to a US style address (see FIG. 4). Again, following display of those data entry fields 24, the user can then enter the US style address.

The processor 1 also enables a user to define the further data entry fields corresponding to a particular data entry field via the keyboard 2, mouse 3 and display 4. The newly defined set of data entry fields can then be stored in the store 6 for subsequent use. The manner in which the data entry form itself is defined by data in the store 6 is conventional and will be well understood by a person of ordinary skill in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CDROMs, as well as transmission-type media, such as digital and analog communications links.

We claim:

1. A system for controlling the appearance of a data entry form on a display to which it is connected for use in entering data into a database, the system comprising a store for storing attribute data defining attributes of a data entry form having at least one data entry field and, for the one data entry field, storing data values and corresponding attribute data defining at least one further data entry field for each of at least two data values which may be entered in the one data entry field; and a controller for causing the data entry form to be displayed on a display in accordance with the stored attribute data, and for monitoring data values entered into said one data entry field, comparing said data value with said prestored data values for that data entry field and, if a match is found, displaying the or each corresponding further data entry field according to the stored attribute data.

2. A system according to claim 1, wherein the controller is adapted to enable a user to define the content of the store.

3. A method for controlling the appearance of a data entry form on a display, the method comprising causing a data entry form to be displayed on a display in accordance with stored attributes, the data entry form having at least one data entry field; monitoring data values entered into said at least one data entry field, comparing said data values with prestored data values for that field and, if a match is found, displaying one or more corresponding further data entry fields.
